(19) United States
(12) Patent Application Publication
(10) Pub. No.: US 2014/0330673 A1
(43) Pub. Date: Nov. 6, 2014

(54) Remote Authentication of Replaceable Fuel Cartridge

(71) Applicant: Intelligent Energy Limited, Leicestershire (GB)

(72) Inventors: Henri Winand, Leicestershire (GB); Allan McNichol, Long Beach, CA (US)

(21) Appl. No.: 14/334,313

(22) Filed: Jul. 17, 2014

Related U.S. Application Data
(63) Continuation of application No. PCT/US2013/022090, filed on Jan. 18, 2013.
(60) Provisional application No. 61/588,495, filed on Jan. 19, 2012.

(51) Int. Cl. H01M 8/04; G06Q 30/06

(52) U.S. Cl. CPC H01M 8/04208; H01M 8/04089; G06Q 30/0639
USPC 705/26.9; 235/375

(57) ABSTRACT

A device is disclosed, having a programmable processor programmed to cause a fuel cell authentication device to obtain a first unique identifier element (UIE) associated with a first hydrogen fuel cartridge and host information associated with a host device configured to use fuel from the first fuel cartridge. Said device may determine that the first fuel cartridge is authorized for use with the host device, based on data exchanged via a data communication network with a remote cartridge tracking system, the first UIE, and the host information. Yet further, the authentication device transmits authorization data to the host device indicating that the host device is permitted to use fuel from the first fuel cell cartridge.

### RELATED APPLICATION

This application is a national stage entry of PCT/US/2013/022090, filed Jan. 18, 2013, which claims the benefit of 61/588,495 including the Appendix, filed Jan. 19, 2012, the disclosures of which are incorporated by reference in their entirety.

### FIELD OF THE DISCLOSED SUBJECT MATTER

This disclosure relates to techniques for managing the use and distribution of fuel cell cartridges for fuel-cell power systems.

### BACKGROUND

With the increased use of mobile electronic devices, including, but not limited to, smart phones, laptop computers, and tablet computers, demand for portable power systems has increased. A popular solution is the use of rechargeable batteries, such as lithium-ion or lithium polymer batteries. For many mobile electronic devices, rechargeable batteries, even when replaceable by a user, are left in the device during use and charging of the battery.

Despite advances in battery designs leading to reduced size and increased capacity, rechargeable batteries impose a number of restrictions on users. First, battery capacity is often only enough to provide for a few hours of active use for many mobile electronic devices. For example, many laptop computers include batteries sufficient for around 5 hours of use, and many smartphones include batteries sufficient for approximately a full day's use. Second, rechargeable batteries must be recharged, which generally requires multiple hours to fully recharge a battery. The combined need to have an appropriate charging device on hand, access to an electrical outlet for the charging device, and adequate time to leave the mobile device attached to the charger for charging, imposes a significant inconvenience on users. Although some devices feature user-replaceable rechargeable batteries, and in theory a user might have an extra charged battery on hand, in practice users rarely find this to be a convenient solution.

Fuel cell technologies have advanced, in terms of size, reliability, and cost, to where fuel cell based power systems can replace or supplement conventional rechargeable battery based solutions. One advantage of fuel cell systems is increased energy density over rechargeable battery technologies. For example, a hydrogen fuel based fuel cell system, including the weight of hydrogen fuel, a storage canister for the fuel, a fuel cell stack, and a “balance of plant” for a fuel cell subsystem, can offer approximately a 1-fold increase in energy density over a lithium-based battery solution. As a result, in comparison to battery-based counterparts, fuel cell based power allows for lighter designs and/or greater run time.

However, fuel cell based power imposes a significant requirement: ensuring there is adequate fuel on hand. The fuel is volatile, and often compressed at a significant pressure, meaning that appropriate storage must be provided for the fuel. For example, the use of cartridges for storing compressed hydrogen is known in the art, and provides a safe and reliable mechanism for supplying fuel to fuel cell powered devices. However, a convenient mechanism for controlled distribution and reuse of such cartridges is required in order to achieve successful commercial application of fuel cell power technologies.

One conventional technique has been the use of cartridges, such as those described in U.S. Pat. Nos. 7,655,331, 7,401,712, 7,306,863, 6,828,049, and 7,914,945 these cartridges require memory components and/or other communication components to enable bi-directional communication between a cartridge and a fuel cell power system. However, the introduction of such components into a cartridge imposes higher unit costs for manufacturing and recycling of spent cartridges.

### DRAWINGS

FIG. 1 illustrates a number of components for managing the use and distribution of fuel cell cartridges for fuel-cell power systems.

FIG. 2 is a flow diagram of a user utilizing an application in connection with authentication of a fuel cartridge;

FIG. 3 illustrates an example of a back channel supply chain in connection with the use and distribution of fuel cell cartridges for fuel-cell power systems; and,

### APPENDIX “A”

All callouts in the attached figures and appendix are hereby incorporated by this reference as if fully set forth herein.

### DETAILED DESCRIPTION

It should be appreciated that, for simplicity and clarity of illustration, elements shown in the figures have not necessarily been drawn to scale. For example, the dimensions of some of the elements are exaggerated, relative to each other, for clarity. Further, where considered appropriate, reference numerals have been repeated among the Figures to indicate corresponding elements. While the specification concludes with claims defining the features of the present disclosure that are regarded as novel, it is believed that the present disclosure's teachings will be better understood from a consideration of the following description in conjunction with the figures and appendix in which like reference numerals are carried forward.

Host 110 is a fuel cell powered device, configured to receive a replaceable fuel cartridge 120 and provide power to powered device 160 by processing fuel provided by replaceable fuel cartridge 120. A receiving portion of host 110 mates with and/or accepts a dispensing 500 of cartridge 120. At least one valve 122 controls a flow of fuel from cartridge 120 to a fuel cell stack 123 included in host 110. This fuel flow may pass through a balance of plant (BOP). The fuel cell stack and BOP form a fuel cell power supply. Such fuel cell power supplies are known in the art, and are available in a wide range or capacities and capabilities. For example, in some exemplary implementations, host 110 may be small enough for inclusion in a smart phone device. In others, host 110 may be a larger desktop unit which provides power to a separate powered device 160 with more significant power requirements than the aforementioned smart phone device. In other exemplary implementations, host 110 may be a vehicle, such as an automobile, with substantial power requirements.

Host 110 also includes a programmable processor 112, which is programmed to control operation of host 110. Additionally, host 110 may include wireless communication circuitry 111, which is configured to provide for wireless communication with other devices, such as communication device 130, via techniques such as, but not limited to, 802.11 Wi-Fi, Bluetooth, cellular, RF, and optical communications. Such communication is discussed further below.

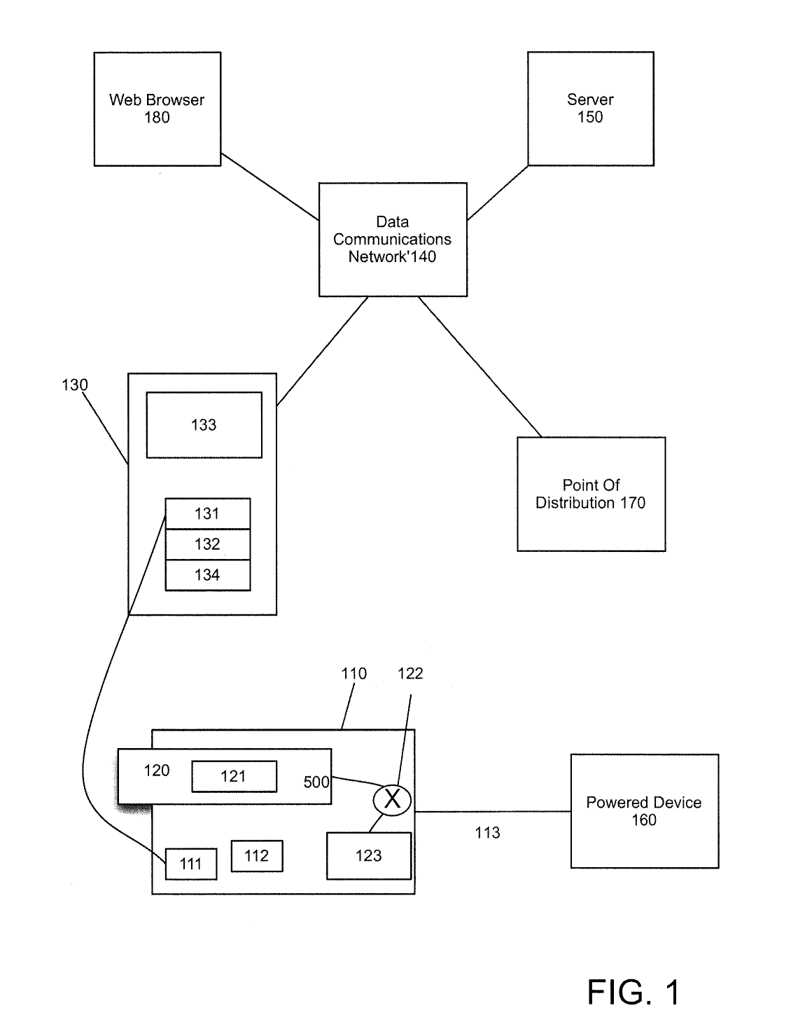

In some exemplary implementations, as illustrated in FIG. 1, host 110 may be a separate device from a powered device 160, with a power cable 113 providing power to powered device 160. In some exemplary implementations, there may be more than one powered device 160. Additionally, power cable 113 may be configured to provide bidirectional data communication between host 110 and powered device 160.

In some exemplary implementations, host 110 may be integrated in a single housing with powered device 160. In such exemplary implementations, host 110 may make use of a programmed processor and data communication circuitry already included in powered device 160, thereby reducing costs of production and power consumption.

In some exemplary implementations, host 110 may be configured to accommodate multiple cartridges, whether to provide increased capacity or to better permit “hot swapping” of an empty first cartridge with a filled second cartridge while host 110 obtains fuel from a third cartridge. In some exemplary implementations, host 110 may include an internal fuel reservoir allowing for a brief period of operation without a fuel cartridge inserted in host 110, in order to facilitate hot swapping for a host 110 configured to only accommodate a single fuel cartridge 120.

PEM fuel cells require hydrogen fuel to generate electricity. Hydrogen can be stored as-is or can be produced on demand. In certain applications, it is useful to have replaceable hydrogen supplies which may be supplied as pressurized gas in tanks (also known as a container, outer shell, tank, canister or cartridge) or hydrogen stored in metal hydrides, in slurries or in other substrates. Hydrogen may also be supplied in the form of a precursor chemical in the form of a chemical hydride. The latter is particularly suited for portable power system whereby the chemical stored in the tank is reacted using suitable methods, as needed, to produce hydrogen on-demand.

Fuel cartridge 120 is a replaceable cartridge containing hydrogen of adequate purity to be utilized as a fuel source for a specific device or model unit of devices with a known fuel cell stack having known requirements for hydrogen purity, configured for insertion in host 110. Fuel cartridge 120 stores fuel for consumption by the fuel cell stack included in host 110. The term “cartridge,” as used in this description, is broadly applicable to any replaceable unit for providing fuel to host 110. Fuel is provided from cartridge 120 to host 110 via a dispensing end. In some exemplary implementations, the fuel is hydrogen, which may be stored, for example, as a compressed gas or bound to a metal hydride.

High purity hydrogen is preferred when used in a PEM fuel cell. Purity above 99% is preferred. Hydrogen above about 99.9% purity is more preferred and hydrogen above about 99.99% purity is most preferred. Assuring proper purity of hydrogen is important as impurities in a hydrogen fuel supply may damage or degrade the performance of the PEM fuel cell. Deterring the use of an unauthorized or unauthenticated hydrogen fuel source is one means of insuring that the end user can rely on the stable and production of power from a PEM fuel cell system. This also enables monitoring and disposal of counterfeit hydrogen supplies. Authentication allows for a safe and inexpensive mechanism by which both fuel and cartridge quality can be verified to ensure reliable operation of host 110.

In some exemplary implementations, cartridge 120 is designed for reuse, in which an appropriate entity assesses a condition of a used cartridge, and, if cartridge 120 is in good condition, refills cartridge 120 with fuel. In some exemplary implementations, such assessment and/or refilling may be performed by a vending machine apparatus.

Cartridge 120 includes an externally visible unique identifier element (UIE) 121. UIE 121 is generally one or more of a code, colors, bar code, numbers, letters, holograms, character, 2D bar code, QR Code (generally described in (ISO/IEC 18004:2000(E)) glyph, image, icons picture, organic chemical, three dimensional (3D) mechanical feature, mechanical strip or matrix, inorganic chemical, doped substrate, natural substrate, manufactured substrate and the like. Chemicals and substrates may form a base layer of label or tape are a support for a UIE or such chemicals and substrates may be a UIE.

In some exemplary implementations, UIE 121 may be affixed to cartridge 120 at a point of distribution, such as point of distribution 170 illustrated in FIG. 1. By producing UIE 121 for cartridge 120 at a time of purchase, UIE 121 can be configured to reflect particular characteristics of cartridge 120, a purchaser of cartridge 120, or a preauthorized host device or group or class of host devices. A UIE 121 reflecting such information can facilitate use cases that do not require network connectivity for use of cartridge 120. For example, if UIE 121 indicates a cartridge has been authorized with use with a particular host 110, it may not be necessary to perform network communication to enable use of the cartridge, although subsequent information about its use by host 110 may be recorded and later transmitted via a data communication network.

In some exemplary implementations, information to be encoded in UIE 121 is cryptographically protected. By providing cryptographic protection, UIE 121 may be more reliably used for the above use cases that do not require network connectivity. In some exemplary implementations, cryptographic protection may be accomplished by encoding the information as binary data, and encrypting the data, and using the encrypted data to produce UIE 121. Devices which intend to read UIE 121 must then decrypt the encrypted data, generally by utilizing a particular decryption key. Many techniques for encryption and decryption are known in the art, including, for example, the Advanced Encryption Standard (AES). This approach renders UIE 121 unreadable to devices unable to perform the decryption. In some exemplary implementations, cryptographic protection may be accomplished by generating by encoding the information as binary data and generating a hash of the binary data, typically after salting the binary data. Then the generated hash is included in UIE 121, along with the information. This approach allows the information to present without obfuscation in UIE 121, but a device can authenticate the information by generating a hash of the information and comparing it with the hash included in UIE 121. Many hash techniques are known in the art, including, for example, SHA-2.

Communication device 130 is configured to transmit and receive data with host 110. In some exemplary implementations, communication device 130 includes wireless communication circuitry 131, which is configured for exchanging data with the wireless communication circuitry 111 included in host device 110 discussed above. In some exemplary implementations, wireless communication circuitry 131 is further configured to exchange data with a data communication network 140 illustrated in FIG. 1. Examples of communication device 130 include, but are not limited to, smartphones, such as the Apple iPhone or various telephone devices utilizing the Android operating system, tablet computers, laptop compute[s, and desktop computers.

Communication device 130 includes programmed processor 132, which is programmed to control communication device 130 in order to perform the various functions and techniques disclosed with respect to communication device 130. Such programming may be provided in the form of firmware, an operating system, and or one or more applications.

In some exemplary implementations, communication device 130 includes a display unit 133 and/or user input circuitry 134 which may include a tactical, verbal or touch screen interface, that allows a user to directly interact with communication device 130. User input devices including, but not limited to, keyboards, touchpads, and touch screens are well known in the art. In some exemplary implementations, communication device 130 may include a microphone and be programmed to perform voice input of commands.

In some exemplary implementations, communication device 130 includes a camera, which enables communication device 130 to capture still or moving images. Such a camera may be used to capture and process an image of UIE 121, in order to generate a code corresponding to UIE 121.

In some exemplary implementations, communication device 130 is configured to obtain its geographical location. In the field of mobile computing devices, there are many techniques known in the art for obtaining a geographic location for a mobile computing device, including, but not limited to, GPS, assisted GPS (AGPS), IP address-based location services, and cellular network location techniques. In some exemplary implementations, where hardware or automated location services are not utilized, communication device 130 may be programmed to request information location from a user, such as a street address. ZIP code, or city.

In some exemplary implementations, a single communication device 130 may be used in connection with multiple host devices. In some exemplary implementations, multiple communication devices may be used in connection with a single host 110.

In some exemplary implementations, communication device 130 may be integrated in a single housing with host 110, and may also receive power from host 110. As an example, one such exemplary implementation may be a fuel cell powered smart phone. In such exemplary implementations, host 110 may make use of a programmed processor and data communication circuitry already included in communication device 130, thereby reducing costs of production and power consumption.

Persons of ordinary skill in the art of computer programming will recognize that the disclosure herein references operations that are performed by a computer system. Operations which are sometimes referred to as being computer-executed. It will be appreciated that such operations are symbolically represented to include the manipulation by a processor, such as a cpu, with electrical signals representing data bits and the maintenance of data bits at memory locations, such as in system memory, as well as other processing of signals. Memory locations wherein data bits are maintained are physical locations that have particular electrical, magnetic, optical, or organic properties corresponding to the data bits.

When implemented in software, elements disclosed herein are aspects of some of the code segments to perform necessary tasks. The code segments can be stored in a non-transitory processor readable medium, which may include any medium that can store information. Examples of the non-transitory processor readable mediums include an electronic circuit, a semiconductor memory device, a read-only memory (ROM), a flash memory or other non-volatile memory, an optical disk, a hard disk, etc. The term module may refer to a software-only implementation, a hardware-only implementation, or any combination thereof. Moreover, the term servers may both refer to the physical servers on which an application may be executed in whole or in part.

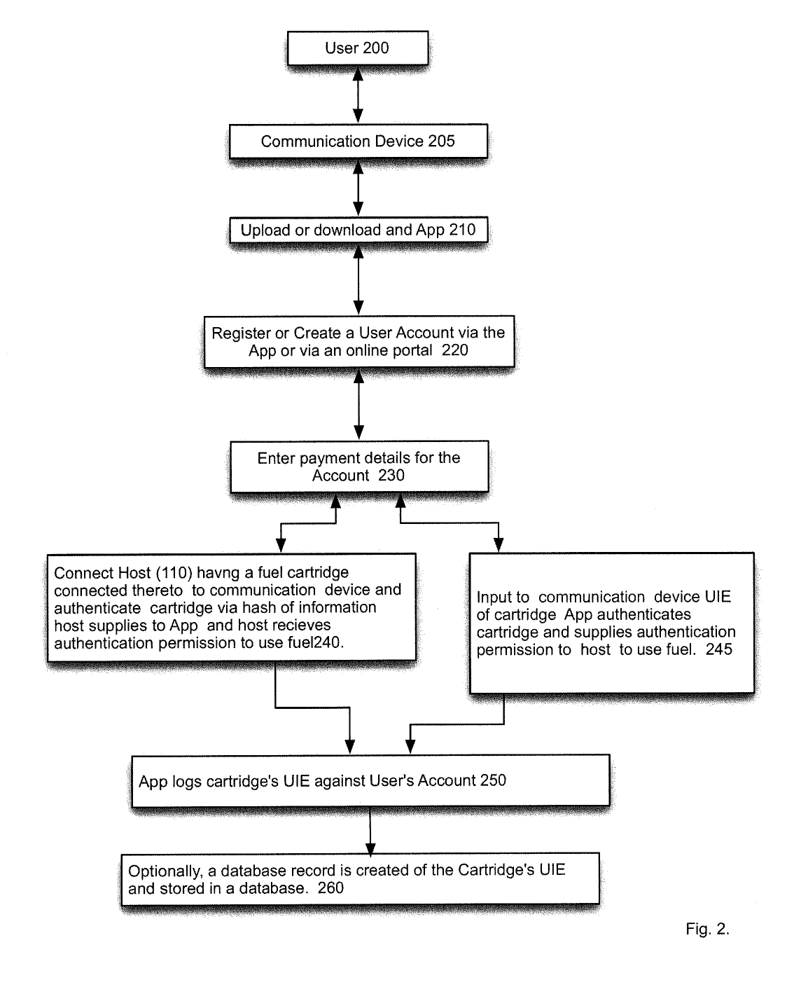

FIG. 2 illustrates a user 200 and communication device 205 interaction. User 200 interfaces with communication device 205 wherein an application “App” for acquiring, using and tracking fuel cartridges is downloaded 210 to the communication device. Visa vie the App a User account can be created 220. Those of ordinary skill in the art will recognize that a User account may also be created online.

### EXAMPLE

Step One: A User 200 utilizes a communication device such as a smart phone or tablet, which is remote from a host device which utilizes a fuel cartridge 205;

Step Two: Either an Application “App” is downloaded onto the communication device via a network or via the network an online portal is accessed 210;

Step Three: The user creates an Account for acquiring and using replaceable hydrogen fuel cartridges 220;

Step Four: The user sets up account details which may include, but is not limited to, payment sources, host identification, location and user identity 230;

Step Five: At least one of option A or option B.

Option A: Connect Host (110) having a fuel cartridge connected thereto to communication device and authenticate cartridge via information host supplies to App. App utilizing local or remote database authenticates the cartridge for use with the host. The host thereafter receives a permission to use the cartridge i.e. to allow the flow of fuel into the fuel cell. The host may receive the permission via a communication from the communication device or from a remote source such as a server via a network 240;

Option B: Input to communication device UIE of cartridge App authenticates cartridge and one of communication device or remote server, via network, supplies permission to host to utilize the cartridge 245;

Step Six: Optional: Log cartridges UIE against user account in the App; and,

Step Seven: Optional: Log or create a database entry of the use of a specific cartridge with a specific UIE 260 which may include the host device it is used in and geolocation.

The App may cause to be displayed on the communication device a menu of items related to fueling and use of the host. Information categories include, but are not limited to charging information, account information and location services to acquire cartridges.

Charging information is data related to the host use of fuel. Information for a fuel cell host may include the performance of each cell in the stack, pressure of the system, temperature, state of hydration, efficiency measured over some period, energy output, and the like. If the host is communicating wirelessly to communication device alarms and the like may be set up to notify the communication device and user if a parameter of operation of the host is outside a limit.

Account information include information on tracking orders of cartridges, identification of cartridges used and state of use, orders of cartridges and an interface to order additional cartridges. The Communication device may also be configured to display a QR code at a point of distribution.

Location services are part of a distribution infrastructure for fuel. The services include using GPS and map Apps to display and/or provide directions to points of distribution wherein an Account holder may obtain cartridges. In some instances the communication device will also provide user credentials to the point of distribution.

Appendix A of applicant's priority provisional application provides drawings showing non limiting examples of illustrative mockups of user interfaces displayed on a display unit 133, for an exemplary implementation of communication device 130 provided using an Apple iPhone smartphone device. Such an exemplary implementation includes a touchscreen user interface, can perform wireless data communication via a cellular data network. Bluetooth, and 802.11 wifi, and can execute programs distributed in the form of “apps.”

Data communication network 140 provides data communication services by which various systems may exchange data with one another. Data communication network 140 does not include a hardwired internal bus used to communicate among computer components within a single housing, such as a PCI or PCI Express bus. One well known example is the Internet. Each of host 110, communication device 130, server 150, powered device 160, point of distribution 170, and web browser 180 may be configured to exchange data with one another by way of data communication network 140. Many techniques, including hardwired broadband and wireless cellular data communications, are known within the art for interfacing various devices with data communication network 140. Additionally, many formats for exchanging data are well known in the art, such as, but not limited to, the use of XML over HTTP for exchanging commands and data among Internet-connected systems.

Server 150 is a computing device configured to exchange data via data communication network 140. Server 150 is configured to provide a database which tracks the availability and usage of fuel cartridges, such as fuel cartridge 120 for use with host 110. Additionally, server 150 is configured to perform authorization for the use of individual fuel cartridges with host devices, as will be discussed in more detail below.

In some exemplary implementations, server 150 may be configured to operate as a web server responsive to requests received from web browser 180 or communication device 130. The web server is configured to allow a user of a web browser application to administrate and/or purchase fuel cartridges. In some exemplary implementations, an application executing on communication device 130 may utilize web browsing software components in order to allow a user to interact with services provided via server 150. However, in exemplary implementations in which UIE 121 is not human-readable, or is inconvenient to enter manually via a keyboard user input device or other manual entry technique, use of “native” facilities on computing device 130 for processing UIE 121 are preferable.

Server 150 is configured to manage and use information about fuel cartridges, in order to assess when they may be properly used by particular users and/or particular host devices. The database provided by server 150 is used to store and retrieve this information. Server 150 associates a unique identifier with each fuel cartridge. However, as in some exemplary implementations a single fuel cartridge may have multiple UIE values associated with it over time, this unique identifier may be distinct and/or independent from a UIE assigned to the fuel cell at that time. Other information stored in connection with each fuel cartridge may include, for example, a cartridge model identification (where multiple models exist), cartridge manufacture information (such as manufacturer and date of manufacture), fuel information (such as fuel type, fuel purity, fuel provider information, fuel manufacture information, and when a cartridge was filled with fuel), fuel consumption information (such as an amount of fuel filled into a cartridge, an amount of fuel withdrawn from a cartridge, and whether a cartridge is considered empty), reuse information (such as whether a cartridge is no longer in use, assessment information such as whether a cartridge is considered damaged, number of times the cartridge has been refilled, and who has assessed and/or refilled a cartridge), point of distribution information (such as where a cartridge can be purchased, where a cartridge has been purchased, and shipment information), customer information (such as an identification of a customer who has purchased or otherwise has a cartridge), host device information (such as identification of a host device in which a cartridge is currently or previously installed), and authorization information (such as a host device or devices for which use of a fuel cylinder has been authorized).

In some exemplary implementations, server 150 is configured to manage and use information relating to individual host devices. The database provided by server 150 is used to store and retrieve this information. Such information may include, for example, model information (which may be connected with other information such as cartridge model compatibility), warranty information, owner information, location information, fuel consumption information, power generation information, and maintenance information.

In some exemplary implementations, server 150 is configured to manage and use information relating to customers making use of fuel cartridges managed by server 150. Such customers may be individuals, groups of individuals, or organizations. In some exemplary implementations, a corporate account may be created, with associated individual accounts, possibly with varying properties. The database provided by server 150 is used to store and retrieve this information. Such information may include, for example, name information, billing information (including, for example, credit card information), shipping information, contact information (such as telephone, mail, and email), purchase information, subscription information (for example, a customer may have an associated monthly amount of fuel or generated power), contract information (such as service level agreements), associated communication devices, associated host devices, and associated fuel cartridges.

In some exemplary implementations, server 150 is configured to manage and use information relating to points of distribution for fuel cartridges managed by server 150. The database provided by server 150 is used to store and retrieve this information. Such information may include name, contact information, shipment information, location, and inventory information.

Additionally, a historical record of such information items may also be recorded, to provide a record of how such information has changed over time.

As will be appreciated by those skilled in the art, server 150 may be configured to manage and use additional items of information, including information useful for implementing the subject matter disclosed in this application.

To provide greater privacy and security, the communication and storage of the above information by server 150 may be encrypted.

In some exemplary implementations, server 150 and host 110 may be configured to communicate directly with each other. This may be used to communicate information about fuel consumption by host 110, and also allow host 110 to authenticate the use of a particular fuel cartridge 120 by direct interaction with server 150.

As is well known in the art, server 150 may be implemented with a plurality of computer systems. For example, one or more computer systems may be specifically configured as database servers, and another computer system may be configured to provide a web server for responding to commands and queries from other network-connected systems.

Point of distribution 170 represents an entity through which a customer may obtain fuel cartridges. In some exemplary implementations, point of distribution 170 may, for example, provide new fuel cartridges, allow for exchange of a spent fuel cartridge for a filled fuel cartridge, and/or refill fuel cartridges. Depending on particular arrangements made with a customer, this may be performed

In some exemplary implementations, point of distribution 170 has a specific location or locations which a customer may physically visit to obtain a new fuel cartridge. Some of such exemplary implementations may be in the form of automated vending machines. Such locations are typically recorded with server 150, to facilitate their location by customers seeking fuel cartridges. In some exemplary implementations, point of distribution 170 does not have such a location; for example, where point of distribution 170 is an online store via which a customer can arrange for delivery of fuel cartridges.

In some exemplary implementations, point of distribution 170 may be configured to exchange data with data communication network 140. This allows point of distribution 170 to exchange data with other entities such as server 150, communication device 130, and web browser 180. Using data exchanged via data communication network 140, point of distribution 170 may, for example, authenticate and/or report distribution of fuel cartridges to particular customers, communicate inventory status, arrange and track shipments of fuel cartridges to/from point of distribution 170, and allow customers to remotely make purchases of fuel cartridges and reserve cartridges for later pickup at a location for point of distribution 170.

In some exemplary implementations, particular points of distribution may be restricted to particular customers. For example, a corporate customer may arrange for points of distribution for exclusive use by its employees. For other customers, server 150 should be configured not to indicate the availability of such points of distribution.

Having generally described the items illustrated in FIG. 1, a number of techniques are described below regarding the management and distribution of fuel cartridges. These are merely provided by way of example, with the understanding that variations upon the described activities being with the skills in the art. Additionally, the disclosed order of activities is not necessarily required.

1. Authentication of Fuel Cartridge 120 for Use with Host 110
a. Customer obtains unused fuel cartridge 120, which bears UIE 121.
b. Communication device 130 obtains a unique identifier code for fuel cartridge 120 via UIE 121. For example, communication device 130 may make use of a built-in camera to capture an image of UIE 121, which may be processed in part or in full by communication device 130 and/or a remote server in order to generate the identifier corresponding to UIE 121.
c. Communication device 130 obtains host information associated with host 110. Such information may be, for example, entered by a user or obtained via wireless communication with host 110.
d. Communication device 130 determines whether fuel cartridge 120 is authorized for use with host 110, based on data exchanged with server 150, the unique identifier code, and the host information. In some exemplary implementations, customer information, such as a customer identifier, may also be submitted to server 150. For example, the unique identifier code and host information may be transmitted to server 150, which is configured to determine whether fuel cartridge 120 may be used, an indication of which is returned to communication device 130. This determination may be based on, for example, (1) compatibility between the model of fuel cartridge 120 and the model of host 110, and/or (2) information recorded in server 150 regarding previous use of fuel cartridge 120, such as whether its supply of fuel has been spent or its previous usage by host devices. Additionally, determination may be based on a user or customer identifier, for example an identifier for the customer, for a user or customer associated with host device 110. For example, a particular customer may be subject to a service contract covering particular types of fuel cartridges.
e. If communication device 130 determines fuel cartridge 120 is authorized for use with host 110, it transmits authorization data to host 110 that host 110 is permitted to withdraw fuel from fuel cartridge 120.

In some exemplary implementations, server 150 may already have recorded some information in connection with a customer being associated with host 110, and has obtained fuel cartridge 120, in which case it is unnecessary to collect and transmit such information to server 150 in connection with authenticating fuel cartridge 120.

2. Recording Fuel Consumption Information at Server 150
a. Host 110 records a withdrawal of fuel from fuel cartridge 120. In some exemplary implementations, host 110 may be capable of measuring and recording that an arbitrary amount of fuel has been withdrawn from fuel cartridge 120. In some exemplary implementations, host 110 may simply record that the fuel from fuel cartridge 120 has been exhausted (in such exemplary implementations, host 110 is typically capable of determining that fuel cartridge has nearly exhausted its supply of fuel, allowing a customer to be warned that replacement of fuel cartridge will be necessary).
b. Communication device 130 receives the fuel consumption information from host 110. This may be done periodically at times when host 110 is able to communicate with communication device 130. In some exemplary implementations, power generation information is also reported by host 110, allowing for more detailed usage and efficiency information to be determined.
c. Communication device 130 transmits the fuel consumption information to server 150.

In some exemplary implementations, host 110 may have network connectivity, allowing it to directly communicate the above fuel consumption information to server 150. In such exemplary implementations, communication device 130 may obtain fuel consumption information via server 150.

3. Locating a Point of Distribution for a Fuel Cartridge for Host 110
a. In some exemplary implementations, communication device 130 obtains information identifying host 110, for which a customer wishes to obtain a fuel cartridge.
b. Communication device 130 obtains a geographic location. Alternatively, a customer may identify a particular location of interest. For example, a customer may be interested in identifying points of distribution near their place of work, even if they are not at work at that particular moment. As another example, communication device 130 may be configured to display a map-based interface, upon which “pinpoints” for points of distribution may be displayed. By changing a location around which the map is centered, a new location can be specified around which points of distribution may be identified.
c. Communication device 130 issues a request to server 150 for points of distribution near the geographic location. This request may include the information identifying host 110. This request may specify additional criteria for “filtering” points of distribution at server 150. For example, a customer may have a fuel service contract allowing for free exchanges of fuel cylinders at particular points of distribution. The customer may wish to identify only such points of distribution, or under certain circumstances make “out of network” purchases of exchanges of fuel cartridges.
d. Server 150, using information recorded in its database about the locations of points of distribution, identifies points of distribution near the specified location and responsive to other criteria specified in the request received from communication device 130. In some exemplary implementations, server 150 attempts to identify whether possible points of distribution make available fuel cartridges compatible with host device 110. In some exemplary implementations, server 150 obtains inventory information for possible points of distribution to confirm that a customer may obtain or reserve a fuel cartridge at a given point of distribution (thereby improving customer satisfaction by avoiding wasted customer effort in visiting or contacting a point of distribution that cannot provide an appropriate fuel cartridge).
e. Server 150 returns information about the identified points of distribution. The returned information may include, for example, for each point of distribution a location and/or contact information.
f. Communication device 130 displays information about the points of distribution on display unit 133. In some exemplary implementations, the points of distribution may be presented on a map-based interface on display unit 133. In some exemplary implementations, communication device 130 may be further configured to allow a customer to purchase or reserve fuel cartridges at a specified point of distribution.

In some exemplary implementations, communication device 150 may also be configured to identify points of distribution which do not have a nearby physical location. For example, an online-only point of distribution may be identified, through which a customer can request shipment of a fuel cartridge.

4. Purchase and Pre-Authorization of a Fuel Cartridge Via Communication Device 130
a. Communication device 130 is configured to allow a customer to obtain a fuel cartridge from a point of distribution 170, and issues a request for a fuel cartridge from the point of distribution 170.
b. Point of distribution 170 confirms that the customer may obtain the fuel cartridge. Additionally, point of distribution 170 provides information pertaining to a UIE assigned to the fuel cartridge. In some exemplary implementations, communication device 130 can be used to authenticate the pickup of a fuel cartridge. For example, communication device 130 may be configured to display a QR code on display 133, which can be processed at a point of distribution.
c. In some exemplary implementations, point of distribution 170 communicates to server 150 a pending transfer of fuel cartridge 120 to the customer, and obtains authorization for use of fuel cartridge 120 by the customer or by host 110. This authorization is transmitted to communication device 130. In some exemplary implementations, communication device 130 uses the information pertaining to the UIE assigned to fuel cartridge 120 to determine that fuel cartridge 120 is authorized for use with host 110. By pre-authorizing the fuel cartridge 120 before it is actually obtained by the customer, communication device 130 may record the authorization at a time when access to data communication network 140 is available.
d. At a later time, communication device 130 transmits authorization data to host 110 that host 110 is permitted to withdraw fuel from fuel cartridge 120.
   Disposal, Return, and/or Recycling of Fuel Cartridges

In some exemplary embodiments, point of sale 170 may serve as a drop off point for spent fuel cartridges. At such a point of sale, a customer may drop off spent fuel cartridges and/or obtain fill replacement fuel cartridges.

In some exemplary embodiments, communication device 130 may be programmed to facilitate the return and recycling of cartridges. Communication device 130 may be programmed to identify an appropriate facility for recycling a cartridge, and may be configured to display locations of such facilities on a map-based display. Communication device 130 may be programmed to make shipping arrangements for a cartridge, including, for example, pickup of cartridges or the generation of shipping labels for convenient shipment of cartridges. In conjunction with such shipment of cartridges, shipments of filled replacement cartridges may be arranged to ensure that a customer has a continuous supply of fuel for host 110. Server 150 may be programmed to manage and make use of information relating to the availability of cartridges at various locations for shipment, and tracking information for cartridges.

In some exemplary embodiments, a customer may receive credit for a returned cartridge. Such a credit may be applied when a cartridge is returned to drop off point. As another alternative, such a credit may be applied at a time subsequent to its return, such as after it has been processed at a centralized recycling facility. Credit may be in the form of, for example, points or currency. Credit may be applied, for example, to the purchase or replacement of fuel cartridges. In some exemplary embodiments, frequent or high-volume customers may receive additional “appreciation” credit. Server 150 may be configured to manage and make use of information tracking returned cartridges and credits associated with the return of cartridges.

Also the above paragraphs discuss the return of spent cartridges, similar techniques may be used to return and/or exchange damaged or defective cartridges. For example, communication device 130 may be programmed to provide an interface to identify a defective cartridge, and make arrangements for replacement of the defective cartridge.

### Carbon-Tracking

Via the UIE mechanism, it is possible to track the origin of various fuel cartridges. In the example of hydrogen fuel, hydrogen may be produced by various techniques, including, but not limited to reforming of methane, electrolysis of water by electricity (with the electricity generated by various techniques such as combustion, hydroelectricity, wind power, solar power, etc.), and photocatalytic water splitting under solar light. A “carbon footprint,” measured for example in terms of grams of carbon dioxide generated to produce each kilogram of hydrogen fuel, can be attributed to each cartridge, which reflects the amount of carbon dioxide generated not only in producing hydrogen fuel, but also, optionally, other carbon dioxide generated for manufacturing of a cartridge, packaging for a cartridge, and distribution of the cartridge. Such information may allow various manufacturers of cartridges to distinguish themselves based on the carbon footprint of their cartridges. In other instances comparisons of the amount of carbon footprint that a traditional battery source would generate as opposed to utilizing a high purity hydrogen source with a fuel cell.

For fuel cartridges tracked by server 150, such carbon information may be stored in the database for server 150. Also, as discussed previously, usage information may be collected from host 110. Such information can be uses to determine a “carbon efficiency,” such as grams of carbon dioxide produced per kilowatt-hour output by host 110. Communication device 130 may be configured to display such information to a customer. In some exemplary implementations, such information may be used in schemes or markets for carbon dioxide emissions trading.

Although in some exemplary implementations detailed information about customers and their consumption of fuel cylinders may be generated and recorded, in some exemplary implementations there much more limited information may be used and/or recorded. For example, the described systems may be configured to perform a simple compatibility check between fuel cylinder 120 and host 110, to ensure their safe and reliable use. Such a compatibility check may simply confirm that the models and/or fuel types may be used with each other, without communication and/or recording of UIE information of information which specifically identifies host 110 or a customer.

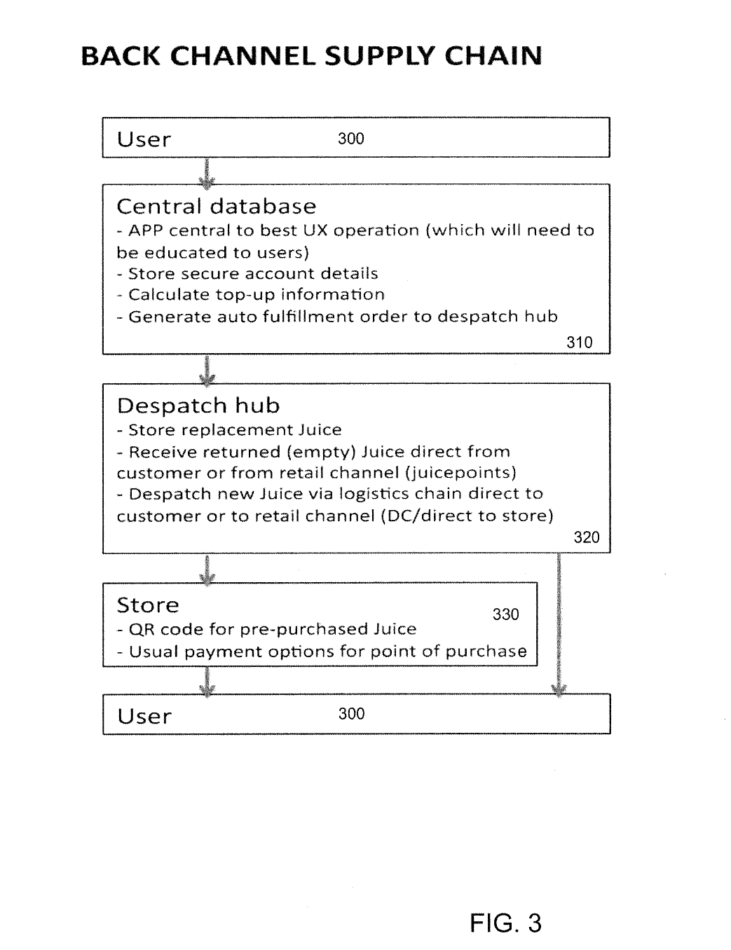

FIG. 3 illustrates an example of a back channel supply chain in connection with the use and distribution of fuel cell cartridges for fuel-cell power systems, which allows for, among other things, automatically ensuring that a user is provided with a ready supply of filled fuel cartridges. As illustrated, a user 300, via a software application, interacts with a central database system, including providing user account details which are stored securely by the central database. Additionally, information is provided to the central database regarding fuel cartridge usage. Based on this information, the central database system calculates top-up information and generates auto fulfillment orders for handling by the dispatch hub 310.

The dispatch hub stores replacement fuel cartridges, which are dispatched via logistics chains directly to users and/or retail channels. In some cases, the dispatch hub also handles the receipt of spent fuel cartridges from users and/or retail channels. In some such cases, the dispatch hub, in connection with the receipt of spent fuel cartridges, may perform one or more of the following: assess the condition of cartridges, refuel cartridges, and provide credits to users for the return of cartridges.320

For fuel cartridges dispatched to retail stores, a UIE, such as a QR code, may be used in connection with the distribution and/or sale of fuel cartridges 330. Various payment options, including acknowledgement of the above-mentioned credit for the return of spent fuel cartridges, may be recognized by retail stores.

Aspects of the disclosed subject matter can be implemented in any convenient form, for example using dedicated hardware, or a mixture of dedicated hardware and software for the processing of the signals. The processing apparatuses can comprise any suitably programmed apparatuses such as a general purpose computer, personal digital assistant, mobile telephone (such as a WAP or 3G-compliant phone) and so on. Since the processing of the disclosed subject matter can be implemented as software, each and every aspect of the disclosed subject matter thus encompasses computer software implementable on a programmable device. Hence, aspects of the disclosed subject matter can be executed on a programmable machine, such as, but not limited to, a microcontroller or computer processor. Program aspects of the technology may be thought of as “products” or “articles of manufacture” typically in the form of executable code and/or associated data that is carried on or embodied in a type of machine readable medium. “Storage” type media include any or all of the memory of mobile stations, computers, processors or the like, or associated modules thereof, such as various semiconductor memories, tape drives, disk drives and the like, which may provide storage at any time for the software programming. All or portions of the software may at times be communicated through the Internet or various other telecommunication networks. Such communications, for example, may enable loading of the software from one computer or processor into another computer or processor. For example, software and/or instructions may be communicated from a server to a client. Thus, another type of media that may bear the software elements includes optical, electrical, and electromagnetic waves, such as used across physical interfaces between local devices, through wired and optical landline networks and over various air-links. The physical elements that carry such waves, such as wired or wireless links, optical links or the like, also may be considered as media bearing the software. As used herein, unless restricted to tangible “storage” media, terms such as computer or machine “readable medium” refer to any medium that participates in providing instructions to a processor for execution.

Hence, a machine readable medium may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement the subject matter described in this application. Volatile storage media include dynamic memory, such as main memory of such a computer platform. Tangible transmission media include coaxial cables; copper wire, and fiber optics, including the wires that comprise a bus within a computer system. Carrier-wave transmission media can take the form of electric or electromagnetic signals, or acoustic or light waves such as those generated during radio frequency (RF) and infrared (IR) data communications. Common forms of computer-readable media therefore include for example: a floppy disk, a flexible disk, hard disk, magnetic tape, any other magnetic medium, a CD-ROM. DVD or DVD-ROM, any other optical medium, punch cards paper tape, any other physical storage medium with patterns of holes, a RAM, a PROM and EPROM, a FLASH-EPROM, any other memory chip or cartridge, a carrier wave transporting data or instructions, cables or links transporting such a carrier wave, or any other medium from which a computer can read programming code and/or data. Many of these forms of computer readable media may be involved in carrying one or more sequences of one or more instructions to a processor for execution.

Those of ordinary skill in the art will appreciate that the above disclosure, in which particular methods or techniques may be described in relation to particular items illustrated in figures are merely for the purpose of illustration, and that it is within the ordinary skills of the art to alternatively perform such methods or techniques with other items illustrated. Such alternatives merely illustrate the ease with which, particularly where systems can exchange data with each other, programmed functionality can be moved and/or distributed among a plurality of programmable processors.

It is to be understood that any feature described in relation to any one aspect may be used alone, or in combination with other features described, and may also be used in combination with one or more features of any other of the disclosed aspects, or any combination of any other of the disclosed aspects. Furthermore, equivalents and modifications not described above may also be employed without departing from the scope of the disclosed subject matter.

The many features and advantages of the disclosed subject matter are apparent from the detailed specification, and thus, it is intended by the appended claims to cover all such features and advantages of the disclosed subject matter which fall within the true spirit and scope of the disclosed subject matter. Further, since numerous modifications and variations will readily occur to those skilled in the art, it is not desired to limit the disclosed subject matter to the exact construction and operation illustrated and described, and accordingly, all suitable modifications and equivalents may be resorted to, falling within the scope of the disclosed subject matter.

Further, each of the various elements of the disclosure and claims may also be achieved in a variety of manners. This disclosure should be understood to encompass each such variation, be it a variation of an implementation of any apparatus implementations, a method or process implementations, or even merely a variation of any element of these.

Particularly, it should be understood that as the disclosure relates to elements of the disclosure, the words for each element may be expressed by equivalent apparatus terms or method terms—even if only the function or result is the same.

Such equivalent, broader, or even more generic terms should be considered to be encompassed in the description of each element or action. Such terms can be substituted where desired to make explicit the implicitly broad coverage to which this disclosure is entitled.

It should be understood that all actions may be expressed as a means for taking that action or as an element which causes that action.

Similarly, each physical element, disclosed, should be understood to encompass a disclosure of the action which that physical element facilitates.

To the extent that insubstantial substitutes are made, to the extent that the applicant did not in fact draft any claim so as to literally encompass any particular exemplary implementations, and to the extent otherwise applicable, the applicant should not be understood to have in any way intended to or actually relinquished such coverage as the applicant simply may not have been able to anticipate all eventualities; one skilled in the art, should not be reasonably expected to have drafted a claim that would have literally encompassed such alternative exemplary implementations.

Further, the use of the transitional phrase “comprising” is used to maintain the “open-end” claims herein, according to traditional claim interpretation. Thus, unless the context requires otherwise, it should be understood that the term “comprise” or variations such as “comprises” or “comprising”, are intended to imply the inclusion of a stated element or step or group of elements or steps but not the exclusion of any other element or step or group of elements or steps.

Such terms should be interpreted in their most expansive forms so as to afford the applicant the broadest coverage legally permissible.

1. A fuel authentication device, comprising a programmable processor programmed to cause the fuel authentication device to perform:
obtaining a first unique identifier element (UIE) associated with a first fuel cartridge;
obtaining host information associated with a host device configured to use fuel from the first fuel cartridge;
determining that the first fuel cartridge is authorized for use with the host device, based on data exchanged via a data communication network with a remote cartridge tracking system, the first UIE, and the host information; and,
transmitting authorization data to the host device indicating that the host device is permitted to use fuel from the first fuel cartridge.

2. The fuel authentication device of claim 1, wherein the determination that the first fuel cartridge is authorized for use with the host device is further based on a user identifier associated with the host device.

3. The fuel authentication device of claim 1, wherein the processor is programmed to cause the fuel authentication device to perform:
obtain a second unique identifier element associated with a second fuel cell cartridge;
receive fuel consumption information from the host device regarding use of fuel from the second fuel cartridge by the host device; and
transmit the fuel consumption information to the remote cartridge tracking system.

4. The fuel authentication device of claim 1, further comprising wireless communication circuitry adapted for transmitting data to and receiving data from the host device, wherein the processor is programmed to transmit the authorization data to the host device via the communication circuitry.

5. The fuel authentication device of claim 1, further comprising the host device and a housing containing the host device and the programmable processor.

6. A mobile fuel cartridge locating device, comprising a display unit and a programmable processor programmed to cause a fuel cell authentication device to perform:
obtain information identifying a host device configured to receive fuel from a hydrogen cartridge;
obtain a geographic location for the mobile device;
transmit a request to a remote cartridge tracking system requesting points of sale at which hydrogen cartridges compatible with the host device may be obtained;
receive information regarding a plurality of points of sale in response to the transmitted request; and, display the information on the display unit.

7. The device of claim 6, further comprising a user input device, wherein the processor is programmed to cause the fuel cartridge authentication device to perform:
obtain purchaser information identifying a purchaser;
receive, via the user input device, an indication of a selected point of sale, included in the plurality of points of sale;
transmit a request requesting purchase of a hydrogen cartridge compatible with the host device for the purchaser.

8. The device of claim 7, wherein the processor is programmed to cause the fuel cartridge authentication device to transmit a request requesting the purchased hydrogen cartridge be held at the point of sale for pickup.

9. The device of claim 7, wherein the processor is programmed to cause the fuel cartridge authentication device to transmit a request that the purchased hydrogen cartridge be shipped to the purchaser.

10. The device of claim 7, wherein the processor is programmed to cause the fuel cartridge authentication device to receive a unique identifier element for the hydrogen cartridge; and,
transmit authorization data to the host device indicating that the host device is permitted to withdraw fuel from the purchased fuel cartridge.

11. The mobile fuel cartridge locating device of claim 6, wherein the processor is programmed to cause the fuel cartridge authentication device to perform:
receive fuel consumption information indicating the use of one or more fuel cartridges by the host device;
determine an estimated amount of time before a fuel cartridge change will need to be performed for the host device; and,
display a notification on the display unit that additional fuel should be purchased for the host device, in response to the fuel consumption information.

12. A hydrogen fuel cartridge tracking system, comprising a programmable processor programmed to perform:
receive point of sale information for a first plurality of points of sale, the point of sale information including a location for a respective point of sale;
receive cartridge information for each of a plurality of hydrogen fuel cartridges, the point of sale information indicating one of the points of sale through which the respective cartridge may be purchased;
receive location information specifying a location of a purchaser;
identify a second plurality of points of sale, included in the first plurality of points of sale, based on the location information and point of sale information; and,
transmit the locations for each of the second plurality of points of sale to the purchaser.

13. The tracking system of claim 12, wherein the processor is programmed to perform:
receive host device information identifying a host device configured to receive fuel from a cartridge;
receive an identifier, uniquely identifying one of the plurality of cartridges; and,
transmit an indication that the host device is authorized to withdraw fuel from the identified cartridge.

14. The tracking system of claim 12, wherein the processor is programmed to perform:
receive fuel consumption information indicating a withdrawal of fuel from one of the plurality of fuel cartridges; and,
transmitting an indication that fuel may not be withdrawn from the one of the plurality of fuel cartridges, based on the fuel consumption information.

15. A fuel cartridge authentication system, comprising a programmable processor programmed to perform:
obtaining a first unique identifier element (UIE) associated with a first fuel cell cartridge;
obtaining host information associated with a host device configured to use fuel from the first cell cartridge;
determining that the first cell cartridge is authorized for use with the host device, based on data exchanged via a data communication network with a remote database ;
determining if the cartridge is authentic via a data exchange based on a UIE tracking system; and,
transmitting authorization data to the communication device indicating that the cartridge is compatible with the host device.

16. The system of claim 15 further comprising;
the host contains a fuel cell and balance of plant;
the host system is configured to receive data communications;
the host system is configure with at least one control valve, whereby it can allow or refuse fluid flow of fuel from a connected cartridge;
transmitting to the host device indicating that the host device is or is not permitted to use fuel from the first cartridge; and,
the host system either permits the flow of fuel from the connected cartridge to the fuel cell or refuses the flow.
